(19) United States
(12) Patent Application Publication
(10) Pub. No.: US 2023/0299310 A1
(43) Pub. Date: Sep. 21, 2023

(54) BIPOLAR PLATE, FUEL CELL SYSTEM, AND METHOD FOR MANUFACTURING A BIPOLAR PLATE

(71) Applicant: Robert Bosch GmbH, Stuttgart (DE)

(72) Inventors: Eberhard Maier, Koengen (DE); Florian Alexander Knorr, Stuttgart (DE); Harald Schmeisser, Stuttgart (DE)

(21) Appl. No.: 18/013,818

(22) PCT Filed: Jun. 8, 2021
(86) PCT No.: PCT/EP2021/065235

§ 371 Date: Dec. 29, 2022

(30) Foreign Application Priority Data
Jul. 1, 2020 (DE) 10 2020 208 196.4

(51) Int. Cl. H01M 8/0265; H01M 8/04007

(52) U.S. Cl. CPC H01M 8/0265; H01M 8/04007; H01M 2008/1095

(57) ABSTRACT

The present invention relates to a bipolar plate (100, 200, 403, 405, 407, 409, 500) for a fuel cell, wherein the bipolar plate (100, 200, 403, 405, 407, 409, 500) comprises at least one fluid channel (101, 103, 105, 201, 203, 205, 207, 209, 501) for transporting operating fluids of the fuel cell, wherein the at least one fluid channel (101, 103, 105, 201, 203, 205, 207, 209, 501) comprises an inlet opening for introducing fluid into the at least one fluid channel (101, 103, 105, 201, 203, 205, 207, 209, 501) and an outlet opening for fluid exiting the at least one fluid channel (101, 103, 105, 201, 203, 205, 207, 209, 501), wherein the at least one fluid channel (101, 103, 105, 201, 203, 205, 207, 209, 501) comprises a first region (107, 211, 503) and at least one second region (109, 213, 507), and wherein the at least one second region (109, 213, 503) has a cross-section which is reduced compared to the first region (107, 211, 507) in order to adjust a volumetric flow of fluid which exits the outlet opening.

### BACKGROUND

Fuel cell systems convert hydrogen by means of oxygen into electrical energy, generating waste heat and water. To this end, fuel cell systems comprise at least one fuel cell stack made of a number of fuel cells with an anode which is supplied with hydrogen, a cathode which is supplied with air, and a polymer electrolyte membrane arranged between the anode and the cathode.

Within a membrane electrode assembly (MEA) of a fuel cell, partial electrochemical reactions of hydrogen and oxygen occur in a manner separated by a membrane. The reactions take place within a catalyst layer on a so-called active surface of the MEA.

The reaction gases hydrogen and oxygen, which is provided by the supplied air, as well as cooling liquid are directed via a so-called bipolar plate (BPP) into a respective fuel cell and distributed across an active field, or an active surface, of the fuel cell, in which the reaction gases react with one another.

In order to allow a reaction to occur in an active field, it is necessary not only to distribute a gas distribution of the reaction gases evenly across the active field but also to adjust an even temperature distribution within the active field. To this end, distribution panels through which reaction gases are supplied to the active field and discharged again are generally formed in a bipolar plate.

Since a distribution panel is generally optimized for a supply or discharge of the reaction gases hydrogen and oxygen, or air, a sub-optimal distribution of coolant and a resultant inhomogeneous temperature distribution within the active field often result. The inhomogeneous temperature distribution leads to locally different reaction rates and correspondingly different power densities within the active field.

### SUMMARY

In the context of the invention presented, a bipolar plate, a method for manufacturing the bipolar plate, and a fuel cell system with the bipolar plate are presented. Further features and details of the invention arise from the respective subclaims, the description, and the drawings. Of course, features and details described in connection with the bipolar plate according to the invention also apply in connection with the method according to the invention and the fuel cell system according to the invention, and respectively vice versa, so that with respect to the disclosure, mutual reference to the individual aspects of the invention is or can always be made.

The invention presented serves to adjust optimal reaction conditions when operating a fuel cell system. In particular, the invention presented serves to optimize flow properties of a coolant flow and/or a flow of one or more reaction media through a bipolar plate.

During the structural design of a distribution region of a bipolar plate, it is, in practice, very difficult for all media regions to achieve optimal media flow since the requirements arising from an optimization of coolant chambers, cathode chambers, and anode chambers are partially contradictory. This can lead to situations in which one or more media chambers are not flowed through evenly or are not flowed through as would be necessary for achieving certain properties of a fuel cell, e.g., a maximum service life. It may be desired, for example, to achieve an even cooling distribution across an active field or to achieve a stronger cooling in certain regions, such as in the middle of an active field, or so-called “flowfields.”

It is furthermore conceivable that reaction media are to flow more strongly through certain fluid channels of a fuel cell than other fluid channels in order to, for example, favorably influence or control a moisture distribution or stoichiometry distribution across an active field. Through such flow behavior, various parameters of a fuel cell may be improved. In particular, a controlled flow through fluid channels allows for optimization of a utilization of membrane surface and catalyst loading in order to increase a power density of a fuel cell stack and reduce specific costs.

A bipolar plate for a fuel cell is thus presented. The bipolar plate comprises at least one fluid channel for transporting operating fluids of the fuel cell, wherein the at least one fluid channel comprises an inlet opening for introducing fluid into the at least one fluid channel and an outlet opening for fluid exiting the at least one fluid channel. The at least one fluid channel comprises a first region and at least one second region, wherein the at least one second region has a cross-section which is reduced compared to the first region in order to adjust a volumetric flow of fluid which exits the outlet opening.

The bipolar plate presented serves in particular to generate homogeneous reaction conditions in an active field of a fuel cell. To this end, the bipolar plate can be designed, for example, in such a way that a homogeneous temperature distribution and/or a homogeneous distribution of reaction gases results in the active field. To this end, individual fluid channels of the bipolar plate can be narrowed independently of one another, i.e., without respectively affecting other volumetric flows, in order to compensate production tolerances, for example. Alternatively, individual fluid channels may be narrowed in a concerted manner in order to provide a predetermined distribution pattern of fluid flows, for example.

The bipolar plate may, for example, have a flow geometry acting as a choke. A flow geometry acting as a choke is narrowed toward a flow region of a fluid channel, for example by a deformation or by a material accumulation. By means of a flow geometry acting as a choke, a distribution of respective media flowing through the bipolar plate, in particular of coolant, can be controlled by, for example, reducing flow peaks, i.e., particularly strong volumetric flows, and, as a result, by generating, for example, a homogeneous distribution pattern of media flowing through the bipolar plate. A homogeneous distribution pattern of media flowing through the bipolar plate produces homogeneous reaction conditions in an active field of a fuel cell.

Alternatively, the bipolar plate presented may also be designed to produce inhomogeneous reaction conditions in an active field of a fuel cell. To this end, the bipolar plate can be designed, for example, in such a way that an inhomogeneous temperature distribution or an inhomogeneous distribution of reaction gases or reaction media results in the active field. For example, the bipolar plate may be designed in such a way that a particularly low or particularly high temperature or a particularly low or particularly high concentration of reaction gases results locally.

In order to adjust reaction conditions in an active field of a fuel cell, the bipolar plate presented comprises fluid channels through which, for example, coolant and/or reaction gases flow and can be appropriately directed to an active field of the fuel cell or discharged from the active field.

The cross-sections of the fluid channels of the bipolar plate presented are tapered or reduced in some regions in order to adjust a volumetric flow of fluid flowing through the bipolar plate. For example, a fluid channel may have a cross-section which is partially reduced in some regions, so that a fluid flow flowing through the fluid channel is reduced compared to an embodiment without reduced cross-section and, as a result, a fluid flow flowing through further fluid channels of the bipolar plate, in particular a fluid flow of coolant, is enhanced.

It may furthermore be provided that respective fluid channels arranged at an edge of the bipolar plate have a narrower cross-section than fluid channels in a center of the bipolar plate.

As a result of fluid channels narrowed at the respective edges of a bipolar plate, i.e., a narrowing of in particular respectively outermost fluid channels of a bipolar plate, an incoming medium is increasingly directed into respective non-narrowed fluid channels between the edges, i.e., in a center of the bipolar plate. Correspondingly, fluid channels narrowed at respective edges cause a stronger coolant flow in the center of the bipolar plate.

Through a coolant flow that is stronger in the center of a bipolar plate than at respective edges, a temperature distribution in an active field that is particularly high in the center of the active field and lower at respective edges than in the center can be particularly effectively homogenized.

By reducing, in some regions, the cross-section of fluid channels of the bipolar plate presented, a volumetric flow flowing through the fluid channels can be adjusted in its strength and its location. For example, respective fluid channels arranged at an edge may have a narrower cross-section than fluid channels in a center of the bipolar plate so that a greater volumetric flow flows in the center of the bipolar plate and, correspondingly, more fluid is directed into a center of a respective active field than to its edges. Alternatively, fluid channels with a narrower cross-section may also be used to homogenize, or make uniform, a fluid flow across an active field. In particular, design-related irregularities in the flow behavior of a bipolar plate can be corrected or compensated by a narrowed or reduced cross-section.

Through an optimized distribution or an optimized adjustment of volumetric flows that flow through the bipolar plate presented, inhomogeneous reaction conditions in a fuel cell, such as a locally particularly strong heating in the center of an active field, can be compensated so that the reaction conditions are homogenized.

Alternatively, locally different reaction conditions may be selectively enhanced or attenuated in order to produce, for example, a moisture gradient along an active field of a fuel cell by locally directing a reduced or gradually increasing volumetric flow of coolant into or across the active field.

It may be provided that the at least one fluid channel in the at least one second region may be narrowed by a depression and/or by a material accumulation toward a flow region of the at least one fluid channel.

Flow geometries that result in a predetermined volumetric flow of fluid can be produced in a targeted manner by a depression or a material accumulation. A depression or material accumulation may be provided at any location within the second region of a fluid channel provided according to the invention. The depression or material accumulation may be provided in a punctiform, linear, wavy or in any other technically suitable shape.

The second region provided according to the invention may comprise a single or a plurality of depressions or material accumulations, which may be pronounced to the same or varying degrees.

In order to avoid an interaction between various adjacently arranged fluid channels that share a flank, for example, a reduction of a cross-section of a fluid channel may also take place by arranging material on a fluid channel. Accordingly, a material accumulation causes a reduction of a cross-section of a respective fluid channel independently of cross-sections of further fluid channels.

It may furthermore be provided that the at least one fluid channel comprises a roof region, a bottom region, and two flanks connecting the roof region and the bottom region on respective sides of the at least one fluid channel, and that at least one flank and/or the roof region and/or the bottom region is narrowed in the at least one second region relative to the first region toward a flow region of the at least one fluid channel.

The fluid channels of the bipolar plate presented may be depressed or compressed in order to achieve the reduction of their cross-section provided according to the invention. This may be provided in the embossing tool or a press or die may be used, for example, in order to deform a uniform fluid channel. Alternatively, a fluid channel depressed in some regions may be manufactured directly, for example in a casting process by means of a corresponding mold or in an additive manufacturing process, such as a printing.

It may furthermore be provided that the at least one fluid channel comprises a coolant channel for directing coolant, a hydrogen channel for directing hydrogen, and/or an air channel for directing air.

The narrowing of the cross-section provided according to the invention can be used to adjust all fluids flowing through the bipolar plate.

It may furthermore be provided that the bipolar plate comprises a plurality of fluid channels and respective fluid channels of at least a portion of the plurality of fluid channels in the at least one second region have a different cross-section relative to one another.

Through a plurality of fluid channels having different cross-sections, a distribution pattern of fluid flows can be generated so that, for example, a design-related inhomogeneous distribution pattern is compensated or a particularly inhomogeneous distribution pattern is generated.

In particular, respective reduction positions of cross-sections of respective fluid channels may be determined by means of a mathematical model so that a most suitable distribution pattern of fluid flows for generating optimal reaction conditions in a fuel cell results.

It may furthermore be provided that the bipolar plate comprises a plurality of fluid channels and respective second regions of at least a portion of the fluid channels differ in their position along the bipolar plate.

By differently positioning respective narrowings or respective second regions, a time control of a distribution pattern of fluid flows can take place. Correspondingly, particularly strong effects by fluid channels that are first supplied by a supply flow can be compensated, for example.

It may furthermore be provided that the bipolar plate comprises a plurality of fluid channels and respective second regions of the plurality of fluid channels are shaped in such a way that volumetric flows of fluid flowing out of respective fluid channels differ from one another by at most a predetermined variance.

A particularly even distribution pattern of volumetric flows can be achieved by a minimum variance of various volumetric flows, so that a particular homogeneous power delivery of a fuel cell to which fluid flows is achieved. To this end, for example, a respective fluid channel can be narrowed in an iterative process or successively until a volumetric flow exiting through the fluid channel is within a predetermined variance.

The bipolar plate presented may consist of sheet metal, e.g., sheet steel, graphite, plastic, or any other technically suitable material.

In a second aspect, the present invention relates to a method of manufacturing a bipolar plate. The method comprises a provisioning step in which a bipolar plate comprising at least one fluid channel extending between an inlet opening and an outlet opening is provided and a processing step in which a cross-section of the at least one fluid channel is narrowed in some regions in order to adjust a volumetric flow of fluid exiting the outlet opening.

The method presented serves in particular for manufacturing the bipolar plate presented.

In the provisioning step, the bipolar plate may be formed from a raw material, such as a sheet metal. To this end, a press or die may, for example, be used to provide a blank of the bipolar plate, which is processed in a subsequent processing step by narrowing respective fluid channels.

In particular, the provisioning step may comprise an embossing method, such as hollow embossing.

Alternatively, the provisioning step and the processing step may occur concomitantly in an integral method. To this end, an additive method, such as 3D printing, an injection embossing method, or an injection molding method may, for example, be used to provide the fluid channels directly narrowed when providing the bipolar plate. To this end, the bipolar plate may be provided from a moldable material, such as graphite.

It may be provided that, in the processing step, various fluid channels for directing various fluids are processed in a concerted manner in order to adjust a predetermined flow distribution pattern.

In the provisioning step, two half-shells may be assembled to form a bipolar plate.

By processing a plurality of fluid channels in a concerted manner, a predetermined distribution pattern can be adjusted on a bipolar plate. In so doing, due to the narrowing of a single fluid channel, stronger volumetric flows are distributed to other fluid channels, through a narrowing of the other fluid channels to all fluid channels, so that a predetermined distribution pattern is adjusted. In particular, respective fluid channels may be narrowed in such a way that volumetric flows exiting the respective fluid channels are the same or at most differ from one another by a predetermined variance.

It may furthermore be provided that, in the processing step, various fluid channels for directing various fluids are narrowed by means of material accumulations in order to adjust fluid flows through respective fluid channels independently of one another.

In order to minimize an interaction of volumetric flows caused by processed or narrowed fluid channels, with volumetric flows of other fluid channels, instead of deformation of a fluid channel by bending or pressing, a material accumulation may be applied to a side of a fluid channel facing a flow region, or an inner side, so that an outer side of the fluid channel is unchanged, for example remains smooth or flat, and can serve as the inner side of a further flow channel, for example.

In a third aspect, the invention presented relates to a fuel cell system comprising at least one possible embodiment of the bipolar plate presented.

It may be provided that respective bipolar plates differ from one another in their fluid channel geometries in order to adjust a volumetric flow through the entire fuel cell system.

By using a plurality of bipolar plates comprising fluid channels that are shaped in a concerted manner, a fluid flow through the entire fuel cell system may be accurately predetermined so that for design-related reasons, for example, a smaller volumetric flow of coolant is supplied to slightly thermally stressed regions of the fuel cell system than to highly thermally stressed regions. To this end, for example, only the fluid channels of the bipolar plates that supply fluid to the respective slightly thermally stressed regions can be adapted. Of course, analogously, the adaptation of the fluid channels of respective bipolar plates can also be used to adapt a supply of reaction gases, such as hydrogen and oxygen, or air, so that only the fluid channels that supply regions with reaction gas where little reaction gas is needed are adapted. In particular, by adapting or narrowing respective fluid channels in a first region or a first bipolar plate, an improved supply of a second region or a second bipolar plate can be achieved. Accordingly, respective adapted or narrowed fluid channels may act not only in a reducing but also in an enhancing manner on respective provided volumetric flows of fluids directed through the fuel cell system.

The principle underlying the invention of narrowing fluid channels may also be applied mutatis mutandis to electrolysers or flux batteries.

### BRIEF DESCRIPTION OF THE DRAWINGS

Shown are:

FIG. 1 a possible embodiment of the bipolar plate according to the invention,

FIG. 2 a further possible embodiment of the bipolar plate according to the invention,

FIG. 3 a possible embodiment of the method according to the invention,

FIG. 4 a possible embodiment of the fuel cell system according to the invention,

FIG. 5 a further possible embodiment of the bipolar plate according to the invention.

### DETAILED DESCRIPTION

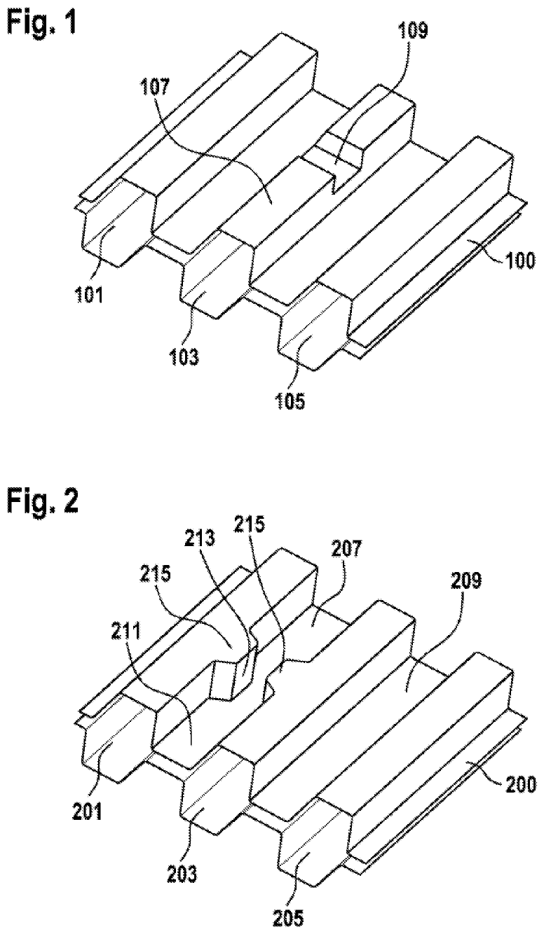

FIG. 1 shows a bipolar plate 100. The bipolar plate 100 comprises a first fluid channel 101, a second fluid channel 103, and a third fluid channel 105 for directing a fluid, such as a coolant.

In order to achieve even supply of fluid to an active field of a fuel cell, the second fluid channel 103 comprises a first region 107 and a second region 109. The second region 109 is narrowed in its cross-section compared to the first region 107. To this end, a roof region of the fluid channel 103 was narrowed or compressed in the second region 109.

Due to the narrowing of the second fluid channel 103, a volumetric flow flowing through the second fluid channel 103 is reduced compared to a volumetric flow flowing through the first fluid channel 101 and the third fluid channel 105. Accordingly, for example, a compressor-related oversupply of fluid to the second fluid channel 103 can be compensated through the narrowing in the second region 109 so that the respective volumetric flows exiting the first fluid channel 101, the second fluid channel 103, and the third fluid channel 105 differ from one another by at most a predetermined variance.

Due to the matched volumetric flows exiting the first fluid channel 101, the second fluid channel 103, and the third fluid channel 105, the bipolar plate 100 supplies fluid particularly evenly to an active field of a fuel cell so that local temperature peaks and/or power peaks and corresponding fuel cell stresses are avoided.

Alternatively, the narrowing in the second region 109 of the second fluid channel 103 may be used to enhance differences in respective volumetric flows flowing through the first fluid channel 101, the second fluid channel 103, and the third fluid channel 105. For example, in the case that fluid flows particularly strongly through fluid channels located at respective edges, i.e., the first fluid channel 101 and the third fluid channel 105, the narrowing in the second region 109 can result in fluid flowing through the first fluid channel 101 and the third fluid channel 105 even more strongly, and respective regions supplied with fluid by the first fluid channel 101 and the third fluid channel 105 are supplied with fluid particularly strongly in order to, for example, compensate for particularly high thermal stress in these regions of the fuel cell.

FIG. 2 shows a bipolar plate 200. The bipolar plate 200 comprises a first fluid channel 201, a second fluid channel 203, a third fluid channel 205, a fourth fluid channel 207, and a fifth fluid channel 209.

While the first fluid channel 201, the second fluid channel 203, and the third fluid channel 205 are used to direct a first fluid, such as a coolant, the fourth fluid channel 207 and the fifth fluid channel 209 are configured for directing further fluids, such as hydrogen and air.

Here, the fourth fluid channel 207 comprises a first region 211 and a second region 213. The second region 213 is reduced by narrowings 215 in its cross-section compared to the cross-section of the first region 211.

The narrowings 215 may be produced by deformation of a flank of the first fluid channel 201, wherein the thereby produced enlargement in the volume of the first fluid channel 201 has an only little or not significant effect on a volumetric flow of fluid flowing through the first fluid channel 201.

In order to eliminate an effect of the narrowings 215 on the volumetric flow flowing through the first fluid channel 201, the narrowings may optionally be formed by material accumulations on the flank of the first fluid channel 201 or on the flank of the fourth fluid channel 207 so that a volume of the first fluid channel 201 is unchanged compared to a volume of the, for example, third fluid channel 205, on which no narrowings are arranged.

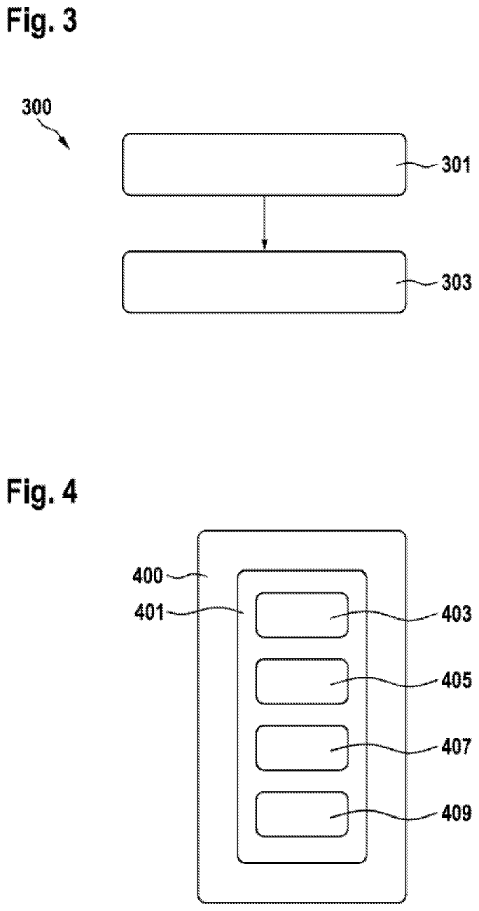

FIG. 3 shows a method 300 for manufacturing a bipolar plate. The method 300 comprises a provisioning step 301, in which a bipolar plate comprising at least one fluid channel extending between an inlet opening and an outlet opening is provided, and a processing step 303, in which a cross-section of the at least one fluid channel is narrowed in some regions in order to adjust a volumetric flow of fluid exiting the outlet opening.

FIG. 4 shows a fuel cell system 400. The fuel cell system 400 comprises a fuel cell stack 401 comprising a plurality of bipolar plates 403 to 409, each comprising a plurality of fluid channels having cross-sections narrowed at least partially in some regions. In this case, the narrowed cross-sections of the respective bipolar plates 403 to 409 are concerted in such a way that a predetermined distribution pattern of fluids flowing through the fuel cell system 400 is adjusted.

In particular, a first bipolar plate 403 may have a particularly large number of fluid channels with narrowings and a second bipolar plate 405 may have a particularly small number of fluid channels with narrowings so that a particularly small quantity of fluid is supplied to regions of the fuel cell system 400 supplied with fluid by the first bipolar plate 403 and a particularly large quantity of fluid is supplied to regions of the fuel cell system 400 supplied with fluid by the second bipolar plate 405. This can in particular alleviate or rectify the problem that an uneven media distribution arises in a fuel cell stack consisting of fuel cells having the same channel geometries.

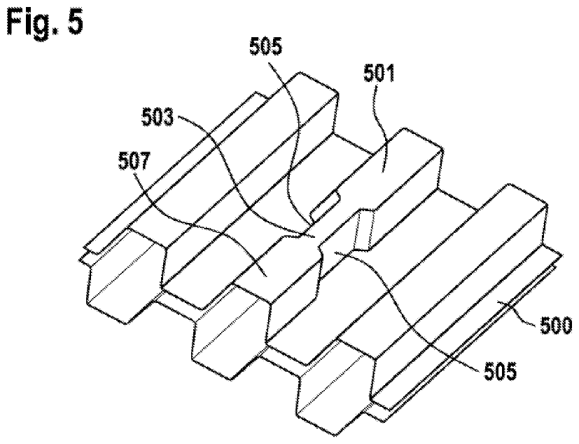

FIG. 5 shows a bipolar plate 500 with a fluid channel 501. The fluid channel is compressed at its flanks 505 in a second region 503. Correspondingly, a volumetric flow flowing through a first region 507 into the second region 503 is throttled or reduced due to a cross-section that is reduced in the second region 503 compared to the first region 507.

Due to its reduced cross-section, the second region 503 causes an adaptation of a volumetric flow exiting the fluid channel 501 to further volumetric flows exiting the bipolar plate 500 so that a homogeneous distribution pattern of volumetric flows arises in an active field of a fuel cell system supplied with fluid by the bipolar plate 500, the throttling, i.e., the reduction of the cross-section of the fluid channel 501 in the second region 503, an adjustment of a volumetric rate flowing through the fluid channel 501 takes place independently of further volumetric flows flowing through further fluid channels of the bipolar plate 500. Accordingly, manufacturing tolerances of the fluid channel 501 can be compensated. Furthermore, a particularly homogeneous distribution pattern of volumetric flows flowing to the active field can be achieved.

The homogeneous distribution pattern of volumetric flows flowing to the active field is achieved by means of the bipolar plate 500, a particularly even stress on the active field and, as a result, a service life of the fuel cell system is maximized.

1. A bipolar plate (100, 200, 403, 405, 407, 409, 500) for a fuel cell,
wherein the bipolar plate (100, 200, 403, 405, 407, 409, 500) comprises at least one fluid channel (101, 103, 105, 201, 203, 205, 207, 209, 501) for transporting operating fluids for the fuel cell,
wherein the at least one fluid channel (101, 103, 105, 201, 203, 205, 207, 209, 501) comprises an inlet opening for introducing fluid into the at least one fluid channel (101, 103, 105, 201, 203, 205, 207, 209, 501) and an outlet opening for fluid exiting the at least one fluid channel (101, 103, 105, 201, 203, 205, 207, 209, 501),
wherein the at least one fluid channel (101, 103, 105, 201, 203, 205, 207, 209, 501) comprises a first region (107, 211, 507) and at least one second region (109, 213, 503), and
wherein the at least one second region (109, 213, 503) has a reduced cross-section compared to the first region (107, 211, 507) in order to adjust a volumetric flow of fluid exiting the outlet opening.

2. The bipolar plate (100, 200, 403, 405, 407, 409, 500) according to claim 1, wherein the at least one fluid channel (101, 103, 105, 201, 203, 205, 207, 209, 501) in the at least one second region (109, 213, 503) is narrowed by a depression and/or by a material accumulation toward a flow region of the at least one fluid channel (101, 103, 105, 201, 203, 205, 207, 209, 501).

3. The bipolar plate (100, 200, 403, 405, 407, 409, 500) according to claim 1, wherein the at least one fluid channel (101, 103, 105, 201, 203, 205, 207, 209, 501) comprises a roof region, a bottom region, and two flanks connecting the roof region and the bottom region on respective sides of the at least one fluid channel (101, 103, 105, 201, 203, 205, 207, 209, 501), and wherein at least one flank and/or the roof region and/or the bottom region in the at least one second region (109, 213, 503) is narrowed relative to the first region (107, 211, 507) toward a flow region of the at least one fluid channel (101, 103, 105, 201, 203, 205, 207, 209, 501).

4. The bipolar plate (100, 200, 403, 405, 407, 409, 500) according to claim 1, wherein the at least one fluid channel (101, 103, 105, 201, 203, 205, 207, 209, 501) comprises a coolant channel for directing coolant, a hydrogen channel for directing hydrogen, and/or an air channel for directing air.

5. The bipolar plate (100, 200, 403, 405, 407, 409, 500) according to claim 1, wherein the bipolar plate (100, 200, 403, 405, 407, 409, 500) comprises a plurality of fluid channels (101, 103, 105, 201, 203, 205, 207, 209, 501) and respective fluid channels (101, 103, 105, 201, 203, 205, 207, 209, 501) of at least a portion of the plurality of fluid channels (101, 103, 105, 201, 203, 205, 207, 209, 501) have a different cross-section relative to one another in the at least one second region (109, 213, 503).

6. The bipolar plate (100, 200, 403, 405, 407, 409, 500) according to claim 1, wherein the bipolar plate (100, 200, 403, 405, 407, 409, 500) comprises a plurality of fluid channels (101, 103, 105, 201, 203, 205, 207, 209, 501) and respective second regions of at least a portion of the plurality of fluid channels (101, 103, 105, 201, 203, 205, 207, 209, 501) differ from one another in their position along the bipolar plate (100, 200, 403, 405, 407, 409, 500).

7. The bipolar plate (100, 200, 403, 405, 407, 409, 500) according to claim 1, wherein the bipolar plate (100, 200, 403, 405, 407, 409, 500) comprises a plurality of fluid channels (101, 103, 105, 201, 203, 205, 207, 209, 501) and respective second regions of the plurality of fluid channels (101, 103, 105, 201, 203, 205, 207, 209, 501) are shaped in such a way that volumetric flows of fluid flowing out of the respective fluid channels (101, 103, 105, 201, 203, 205, 207, 209, 501) differ from one another at most by a predetermined variance.

8. The bipolar plate (100, 200, 403, 405, 407, 409, 500) according to claim 1, wherein respective fluid channels (101, 103, 105, 201, 203, 205, 207, 209, 501) arranged at an edge of the bipolar plate (100, 200, 403, 405, 407, 409, 500) have a narrower cross-section than fluid channels in a center of the bipolar plate (100, 200, 403, 405, 407, 409, 500).

9. A method (300) of manufacturing a bipolar plate (100, 200, 403, 405, 407, 409, 500), wherein the method comprises:
a provisioning step (301) in which a bipolar plate (100, 200, 403, 405, 407, 409, 500) with at least one fluid channel (101, 103, 105, 201, 203, 205, 207, 209, 501) extending between an inlet opening and an outlet opening is provided,
a processing step (303) in which a cross-section of the at least one fluid channel (101, 103, 105, 201, 203, 205, 207, 209, 501) in a second region (109, 213, 503) is narrowed compared to a cross-section of a first region (107, 211, 507) in order to adjust a volumetric flow of fluid exiting the outlet opening.

10. The method (300) according to claim 9, wherein in the processing step (303), various fluid channels (101, 103, 105, 201, 203, 205, 207, 209, 501) for directing various fluids are processed in a concerted manner in order to adjust a predetermined distribution pattern.

11. The method (300) according to claim 9, wherein in the processing step (303), various fluid channels (101, 103, 105, 201, 203, 205, 207, 209, 501) for directing various fluids are narrowed by material accumulations in order to adjust fluid flows through respective fluid channels (101, 103, 105, 201, 203, 205, 207, 209, 501) independently of one another.

12. A fuel cell system (400) comprising at least one bipolar plate (100, 200, 403, 405, 407, 409, 500) according to claim 1.

13. The fuel cell system (400) according to claim 12, wherein the fuel cell system comprises a plurality of bipolar plates (100, 200, 403, 405, 407, 409, 500), wherein respective bipolar plates (100, 200, 403, 405, 407, 409, 500) differ in their fluid channel geometries in order to adjust a volumetric flow through the entire fuel cell system (400).
